(19) United States
(12) Patent Application Publication
(10) Pub. No.: US 2012/0177218 A1
(43) Pub. Date: Jul. 12, 2012

(54) SPEAKER UNIT AND SPEAKER SYSTEM USING SAME SPEAKER UNIT

(76) Inventor: Teppei YAMADA, Tokyo (JP)

(21) Appl. No.: 13/207,483

(22) Filed: Aug. 11, 2011

(30) Foreign Application Priority Data
Jan. 6, 2011 (JP) 2011-001194

(51) Int. Cl. H04R 1/02

(52) U.S. Cl. 381/89

(57) ABSTRACT

A speaker unit includes: two front-side driver units arranged adjacently on the left and right, and two rear-side driver units coupled to respective magnets of the front-side driver units back to back, the two front-side driver units and the two rear-side driver units being attached to a box-shaped mounting frame. One of the front-side driver units and one of the rear-side driver units output audio signals from a media resource, and the other front-side driver unit and the other rear-side driver unit output signals in anti-phase to the audio signals from the media resource.

### BACKGROUND OF THE INVENTION

1. Technical Field

The present invention relates to a speaker unit having plural driver units and a speaker system using the same speaker unit.

2. Background Art

In general speaker systems, vibrations of a diaphragm cause negative vibrations that should not actually exist in a diaphragm-supporting member and, in addition, in the entire enclosure connected thereto due to reaction therefrom. In other words, instead of accurate movement of the diaphragm, the supporting member which supports the diaphragm and, in addition, the enclosure to which the supporting member is fixed starts moving subtly, which results in vibrations of these members. This phenomenon is a so-called “speaker enclosure resonance”. Ceaseless change in internal pressure that is generated in the interior of the enclosure also results in the speaker enclosure resonance.

As a countermeasure for such phenomena, (1) a structure in which a lead mass which is referred to as a dead mass 102 is joined to the back side of a magnet 101 of a dynamic speaker system 100 (see FIG. 12), (2) an invention described in JP-A-2-100500 in which respective drivers of two driver units are bonded or joined back to back to cancel a reaction caused by two diaphragms, and (3) a configuration having duplicated enclosures 111 and 112 (see FIG. 13) are known. However, with the configurations described above, two primordial problems; the speaker enclosure resonance caused by the reaction of the diaphragms, and improper constrain that air spring generated in the interior of the enclosure added to the movement of the diaphragm existing in the enclosure-type speaker system are not solved satisfactorily, so that the accurate reproduction of sounds cannot be expected in the enclosure-type speaker system.

In contrast, there is a known speaker system in which one of a pair of driver units 121 and 122 joined back to back with magnets 121a and 122a is attached to an open baffle plate 120. However, the air load of the front driver unit 121 attached to the baffle plate and the air load of the rear driver unit 122 attached in an uncovered state, which exists little, cannot be equivalent, so that cancellation between these air loads cannot be established (see FIG. 14).

Accordingly, the inventor of the invention has previously invented an open-baffle type speaker system in which the problem of the internal pressure in the dosed box is solved by causing the reactions of the diaphragms to be cancelled and, simultaneously, connecting the rear portion of the front driver unit and the front surface of the rear driver unit via a pipe (see JP-A-2007-235727). In this speaker system, a member that seems to be a box exists. However, it is not actually an enclosure, and corresponds to one piece of uncovered speaker unit including a set of two driver units accommodated in a box, which is attached to an opened baffle plate.

However, in this speaker system, the front surface of the rear driver unit vibrates in a dosed space, while the front driver unit vibrates in an opened space. The internal pressure in the dosed space is kept constant by the vibrations of the front driver unit, while the air loads of the both driver units are not necessarily equal. Also, a back surface of the rear driver unit faces the external space in any case, but it is in a semi-dosed space. Therefore, it is hard to say that air pushed out on the backside and air pushed out on the front side are completely cancelled and, consequently, the reaction force which moves the entire box rearward may be generated. Consequently, an electric energy is not converted into an air energy, but works as an energy to move directly the speaker unit, and hence the entire speaker system.

If the pipe is long, two F₀s that seem to be resonance between front and rear voids appear. If the length of the pipe is reduced, there appears only one F₀, but a slight resonance peak appears. In this manner, when the two driver units are combined, the spaces on the rear side of the front driver unit and on the front side of the rear driver unit have to be connected, and hence increase in length of the pipe cannot be avoided.

Furthermore, air in the pipe does not move in parallel as a mass such as a solid substance, but moves such that air located near the diaphragm move directly due to the viscosity of air, while air in a center portion of the pipe move slightly in retard. Therefore, the internal air in the center portion of the pipe placed between the front and rear diaphragms move as if it is expanded or collapsed just like bread dough. Accordingly, the internal air does not necessarily move in the same phase as the front and rear diaphragms. Consequently the entire speaker system is moved and hence there remains a problem in accuracy of the reproduced sounds.

### SUMMARY OF THE INVENTION

It is an object of the invention to solve the problems described above. That is, it is to provide a speaker unit which can cancel reactions of diaphragms and solve the problem of backpressure of a speaker unit and to provide a speaker system using such speaker unit.

Accordingly, a speaker unit of the invention includes: two front-side driver units arranged adjacently on the left and right, and two rear-side driver units coupled to respective magnets of the front-side driver units back to back, the two front-side driver units and the two rear-side driver units being attached to a box-shaped mounting frame, one of the front-side driver units and one of the rear-side driver units output audio signals from a media resource, and the other front-side driver unit and the other rear-side driver unit output signals in anti-phase to the audio signals from the media resource.

Preferably, the speaker unit is configured in which the mounting frame is formed into a rectangular box shape including a top plate, a bottom plate, a center supporting plate which partitions the mounting frame at the center thereof, a front surface supporting plate, a rear surface supporting plate, and both side plates, rear end portions of respective drivers of the front-side driver units and the rear-side driver units are inserted into and supported by through holes formed through the center supporting plate respectively, and distal end portions of the respective diaphragms of the front-side driver units and the rear-side driver units are fixed respectively to through hole edge portions formed on the front-side supporting plate and the rear-side supporting plate.

Further, the speaker unit may be configured in which the mounting frame is formed into a rectangular box shape including a top plate, a bottom plate, a front surface supporting plate, and a rear surface supporting plate, and both side plates, and distal end portions of the respective diaphragms of the front-side driver units and the rear-side driver units are fixed respectively to through hole edge portions formed on the front-side supporting plate and the rear-side supporting plate.

Furthermore, the speaker unit may be configured in which the mounting frame may include a box-shaped front-side mounting unit and a rear-side mounting unit arranged with facing each other, inner side surfaces of the front-side and rear-side mounting units are provided with through holes formed to correspond to distal end openings of the respective diaphragms of the front-side driver units and the rear-side driver units, and distal end opening edges of the respective diaphragms are tightly fixed to peripheral edge portions of the respective through holes, and back surface sides of the respective diaphragms are exposed to an external space.

Also, a speaker system of the invention is configured to include a speaker unit described as above, and a supporting board of which front side and rear side are exposed to a external space, wherein the speaker unit is attached to the supporting board so as to penetrate therethrough.

With regard to mounting of the speaker unit to the supporting board in the speaker system, in case that a mounting frame is formed into a rectangular box shape including a top plate, a bottom plate, a center supporting plate which partitions the mounting frame at the center thereof, a front surface supporting plate, and a rear surface supporting plate, preferably, the top and bottom plates, the center supporting plate, the front and rear surface supporting plates are crossing through the supporting board, and outer peripheral portions of the mounting frame including center portions between the adjacent front-side driver units, and between the rear-side driver units are attached and fixed to the supporting board.

Further, in case that the mounting frame of the speaker unit is formed into a rectangular box shape including a top plate, a bottom plate, a front surface supporting plate, and a rear surface supporting plate, preferably, the top and bottom plates, the front and rear surface supporting plates are crossing through the supporting board, and outer peripheral portions of the mounting frame including center portions between the adjacent front-side driver units, and between the rear-side driver units are attached and fixed to the supporting board.

Furthermore, in case that the speaker unit includes a box-shaped front-side mounting unit and a rear-side mounting unit arranged with facing each other and crossing through the supporting board, inner side surfaces of the front-side and rear-side mounting units are provided with through holes formed to correspond to distal end openings of respective diaphragms of a front-side driver units and a rear-side driver units, and distal end opening edges of the respective diaphragms are tightly fixed to peripheral edge portions of the respective through holes, and back surface sides of the respective diaphragms are exposed to an external space, preferably, the front-side and rear-side mounting units are crossing through the supporting board respectively, and outer peripheral portions of the front-side and rear-side mounting units including center portions between the adjacent front-side driver units, and between the rear-side driver units are attached and fixed to the supporting board respectively.

Preferably, the above mentioned supporting board is configured into any one of: (1) a flat panel-shaped baffle plate, (2) a supporting board being formed with a rear panel to which the speaker unit is attached and fixed, a top panel and bottom panel extending to forward respectively from top and bottom ends of the rear panel, (3) a supporting board being formed with a rear panel to which the speaker unit is attached and fixed, and side panels extending to forward from both sides of the rear panel respectively, (4) a supporting board being formed into a tubular shape with a rear panel to which the speaker unit is attached and fixed, a top and bottom panels extending to forward respectively from top and bottom ends of the rear panel, and side panels extending to forward from both sides of the rear panel respectively.

The relationship between the mounting frame and the respective driver units is defined so that the spaces formed between the box-shaped mounting frame and the driver units are minimized. It is because the resonance vibrations can hardly be generated by doing so.

### ADVANTAGEOUS EFFECT OF THE INVENTION

According to the speaker unit of the invention, it is configured so that one of the front-side driver units and one of the rear-side driver units of the speaker unit output audio signals from a media resource, and the other front-side driver unit and the other rear-side driver unit output signals in anti-phase to the audio signals from the media resource. Therefore, not only the reaction generated on the back surface side of the diaphragm is cancelled, but also the output sound and the air pressures are cancelled each other out and offset by output of the audio signals in anti-phase each other into a tightly dosed space in the mounting frame. Accordingly, the lowest resonant frequency or the fundamental frequency (F₀) can be lowered in the speaker unit without any remodeling or improving of the driver unit itself.

Also, according to the speaker system of the invention, the speaker unit is attached to the supporting board in which the front side and rear side are exposed to a external space so as to penetrate therethrough, and the anti-phase signals output from the respective diaphragms of the other front-side driver unit and the other rear-side driver unit to the outside space are isolated to the left and right by the supporting board. Accordingly, these signals are not cancelled each other out, and sound faithful to the original sound recorded in the media resource are reproduced.

### BRIEF DESCRIPTION OF THE DRAWINGS

FIG. 1 is a top cross-sectional view showing a speaker unit according to a first embodiment of the invention;

FIG. 2 is a cross-sectional view of a speaker unit according to a second embodiment of the invention;

FIG. 3 is a cross-sectional view of a speaker unit according to a third embodiment of the invention;

FIG. 4 is a perspective view showing a speaker system of another invention in which the speaker unit of the above first embodiment is attached to a flat panel-shaped supporting board (baffle plate);

FIG. 5 is a top cross-sectional view showing the same speaker system taken along a line 5-5 in FIG. 4;

FIG. 6 is a side view of the same speaker system;

FIG. 7 is a perspective view showing a speaker system of the invention in which the speaker unit of the above third embodiment is attached to the panel-shaped supporting board (baffle plate);

FIG. 8 is a cross-sectional view of the same speaker system taken along a line 8-8 in FIG. 7;

FIG. 9 is a perspective view showing an another mode of the speaker system, which the speaker unit of the above first, second, or third embodiment is attached to another mode of the supporting board;

FIG. 10 is a perspective view showing an another mode of the speaker system, which the speaker unit of the above first, second, or third embodiment is attached to still another mode of the supporting board;

FIG. 11 is a perspective view showing an another mode of the speaker system, which the speaker unit of the above first, second, or third embodiment is attached to still more another mode of the supporting board;

FIG. 12 is a vertical cross-sectional view of a principal portion of a speaker system in the prior art;

FIG. 13 is a vertical cross-sectional view of a principal portion of another speaker system in the prior art and

FIG. 14 is a vertical cross-sectional view of a principal portion of still another speaker system in the prior art

### DESCRIPTION OF THE PREFERRED EMBODIMENTS

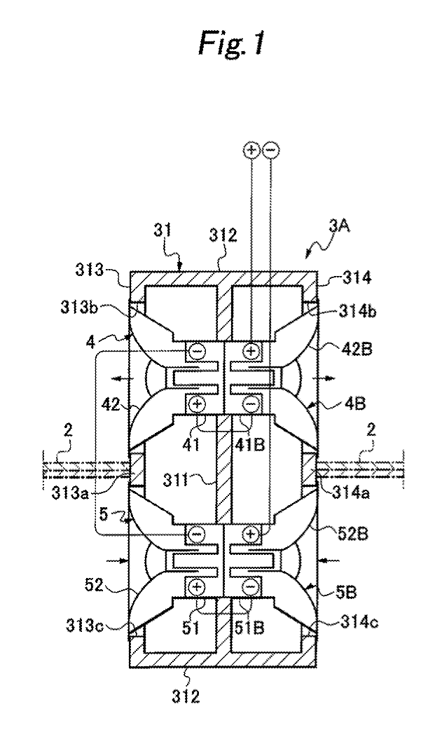

FIG. 1 shows a speaker unit 3A according to a first embodiment of the invention. The speaker unit 3A is configured as a unit composed of four driver units 4, 4B, 5 and 5B in which two front-side driver units 4 and 5 are arranged adjacently on the left and right, and two rear-side driver units 4B and 5B are coupled to respective magnets 41, 41B of the front-side driver units 4 and 5 back to back. The driver units 4, 4B, 5 and 5B are attached to a mounting frame 31.

The mounting frame 31 is formed with medium density fiberboard (MDF) into substantially a box shape, and includes a top plate, a bottom plate, a center supporting plate 311 which partitions the mounting frame 31 at the center thereof, a front surface supporting plate 313, and a rear surface supporting plate 314, and both side plates 312 and 312. The rear-side magnets 41, 41B, 51, and 51B on the back end sides of the respective driver units 4, 4B, 5, and 5B are supported by being inserted into through holes 311a and 311b formed in the center supporting plate 311 respectively, and distal end portions of the diaphragms (cones) 42, 42B, 52, and 52B on the distal end side are attached and fixed respectively to edge portions of the through holes 313b, 313c, 314b, and 314c formed in the front surface supporting plate 313 and the rear surface supporting plate 314 via screws or the like. Although MDF is used in this embodiment as a material for the mounting frame 31, it should not be limited to this material and other synthetic resin, lumber or metal may be used.

The above-described front-side driver unit 4 and the rear-side driver unit 4B are both configured to reproduce audio signals recorded in a media resource such as a CD faithfully without change (indicated by an arrow directed outward in the drawing), while the other front-side driver unit 5 and the other rear-side driver unit 5B arranged adjacently thereto are configured to output signals in anti-phase to those audio signals of the media resource (indicated by an arrow directed inward in the drawing). In other words, the front-side driver units 4 and 5, and the rear-side driver units 4B and 5B arranged adjacently on the left and right are respectively in symmetrical relationship which output the audio signals in anti-phase to each other.

In the speaker unit configured as described above, not only the reaction generated on the back surface side of the diaphragm is cancelled, but also the output sound and the air pressures are cancelled each other out and offset by output of the audio signals in anti-phase each other into a tightly closed space in the mounting frame. Accordingly, the lowest resonant frequency or the fundamental frequency (F₀) of the speaker unit can be lowered.

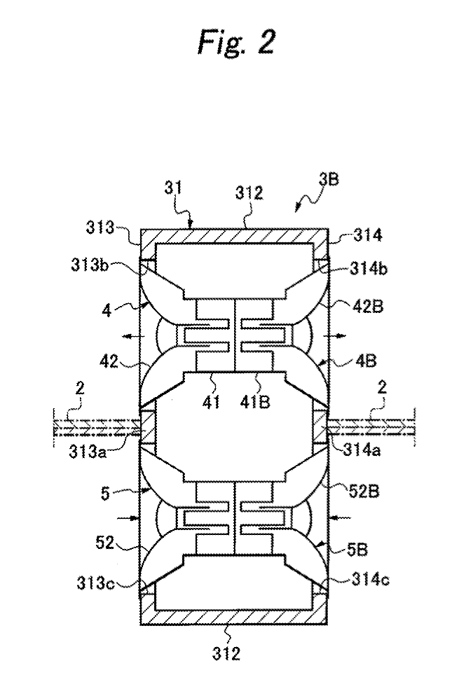

FIG. 2 shows a speaker unit 3B according to a second embodiment of the invention. Other than not having a center supporting plate 311 in the mounting frame 31, the arrangement relationship of the front-side driver units 4, 5 between the rear-side driver unit 4B, 5B is as same in the above first embodiment. Also in this configuration, it can be obtained effects same as the first embodiment.

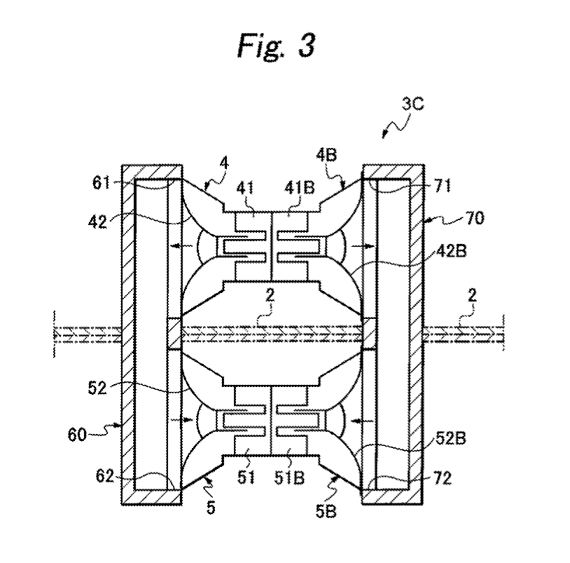

FIG. 3 shows a speaker unit 3C according to a third embodiment of the invention. The speaker unit 3C is configured as a unit including the four driver units 4, 48, 5, and 5B, in which the front-side driver units 4 and 5 are arranged adjacently on the left and right sides, and the rear-side driver units 4B and 5B are coupled to the respective magnets 41 and 41B of the front-side driver units 4 and 5 back to back respectively, which is the same as the first and second embodiments described above. However, how to mount the driver units 4, 4B, 5, and 5B to the mounting frame is significantly different.

That is, the mounting frame includes a front-side mounting unit 60 to which opening edges of the diaphragms 42 and 52 of the front-side driver units 4 and 5 are attached, and a rear-side mounting unit 70 to which opening edges of the diaphragms 42B and 52B of the rear-side driver units 4B and 5B are attached. The front-side and rear-side mounting units 60 and 70 are arranged so as to be apart from each other and face each other. On inner side surfaces of the front-side and rear-side mounting units 60 and 70 facing each other, through holes 61 and 62 corresponding to opening outer edges of distal ends of the respective diaphragms 42 and 52 of the driver unit 4 and 5, and the through holes 71 and 72 corresponding to opening outer edges of distal ends of the respective diaphragms 42B and 52B of the driver units 4B and 5B are formed respectively. The opening edges of the distal ends of the diaphragms 42 and 52, and 42B and 52B are attached respectively so as to close the respective through holes 61, 62, and 71, 72.

The diaphragms 42 and 52, and 42B and 52B of the respective driver units 4, 5, 4B, and 5B are dosed at peripheral edges thereof by the front-side and rear-side mounting units 60 and 70, respectively, and the openings of the distal ends thereof communicate with each other via the through holes 61 and 62, and 71 and 72 in the spaces of the front-side and rear-side mounting units 60 and 70. In contrast, all of back surface sides of the diaphragms 42 and 52, and 42B and 52B are exposed to the outside. Here, the front-side driver unit 4 and the rear-side driver unit 4B are both configured to reproduce the audio signals recorded in the media resource such as CD faithfully without change (indicated by an arrow directed outward in the drawing), while the other front-side driver unit 5 and the other rear-side driver unit 5B arranged adjacently thereto are configured to output signals in anti-phase to the audio signals of the media resource (indicated by an arrow directed inward in the drawing). Also in this configuration, it can be obtained effects same as the first embodiment.

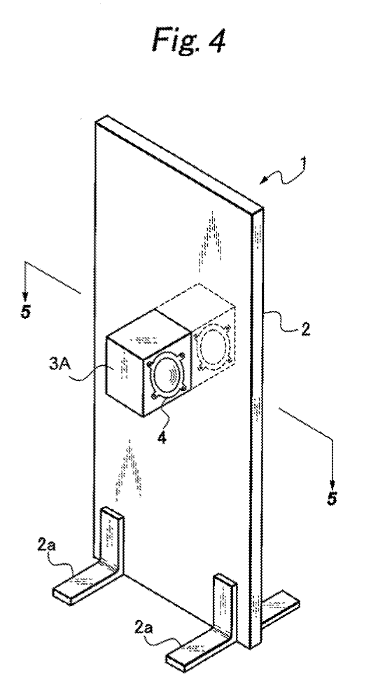

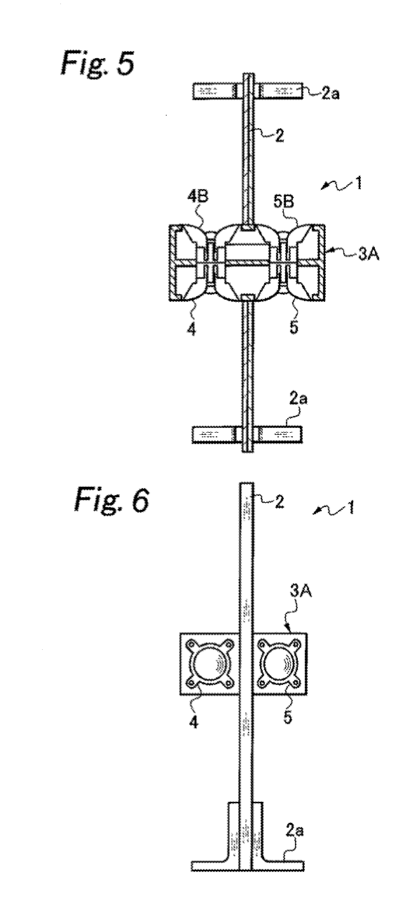

FIGS. 4 to 6 show a speaker system 1, which includes a flat panel-shaped baffle plate 2 placed upright by legs 2a fixed to both sides of a lower edge portion, and the speaker unit 3A attached to substantially a center of the baffle plate 2 so as to penetrate therethrough. The baffle plate 2 is made of a laminated glass, which is superior in sound insulation efficiency. Then, outer peripheral portions of the mounting frame 31 including center portions 313a and 314a of the front surface supporting plate 313 and the rear surface supporting plate 314 remained respectively between the adjacent front-side driver units 4 and 5, and the rear-side driver units 4B and 5B are attached and fixed via screws or the like to the baffle plate 2.

Here, the mounting frame 31 is attached and fixed in such a manner that the front surface supporting plate 313 and the rear surface supporting plate 314 are orthogonal to the baffle plate 2. In other words, the front-side driver unit 4 and the rear-side driver unit 4B are arranged in parallel to the baffle plate 2 with the respective diaphragms 42 and 42B facing opposite sides from each other. Not only the front and rear-side driver units 4 and 4B, and 5 and 5B are arranged respectively in anterior-posterior symmetry, but also the front-side driver units 4 and 5, and the rear-side driver units 4B and 56 are respectively arranged in bilateral symmetry.

The front-side driver units 4 and 5, and the rear-side driver units 4B and 5B are arranged adjacently to each other as much as possible. Attachment of the respective driver units 4, 48, 5, and 5B to the mounting frame 31 is defined such that spaces formed between the respective speaker units and the mounting frame 31 are minimized. In other words, the driver units 4, 5, 46, and 5B are each provided only with a minimum necessary space for the movement of the diaphragms thereof. Factors that may cause air in the spaces to be damped are minimized, so that the air in the interiors is prevented from being compressed or thinned due to the pressure of the diaphragms.

In the speaker system configured as described above, by the arrangement of the front-side driver units 4 and 5, and the rear-side driver units 4B and 5B back to back with the respective magnets joined to each other, the reactions of the diaphragms of the counterparts can be cancelled. In addition, the front-side driver units 4 and 5, and the rear-side driver units 4B and 5B arranged adjacently on the left and right respectively output audio signals in anti-phase to each other, the sound and the air pressures in the spaces in the mounting frame 31 are also cancelled each other and disappeared.

In contrast, on the outside of the mounting frame 31, since the front-side and rear-side driver units 4 and 4B, and the front-side and rear-side driver units 5 and 58 are respectively apart from each other by the baffle plate 2, sound output from the front-side driver unit 4 and the rear-side driver unit 4B are prevented from being cancelled by the anti-phase sound output from the front-side driver unit 5 and the rear-side driver unit 5B and disappeared. Therefore, the audio signals recorded in the media resource can be reproduced faithfully without being adversely affected by the reaction and the back pressure of the diaphragms in the box-shaped mounting frame 31.

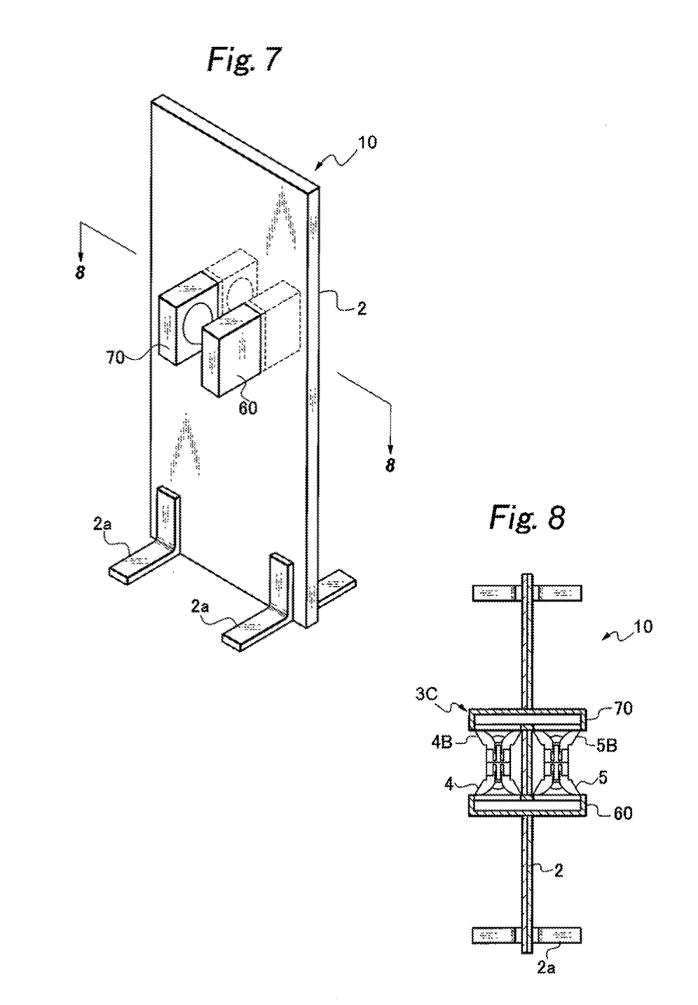

FIGS. 7 and 8 show a speaker system 10, which includes a flat panel-shaped baffle plate 2 and the speaker unit 3C of the third embodiment attached to the baffle plate 2 so as to penetrate therethrough. The front-side and rear-side mounting units 60 and 70 formed into a rectangular box shape are attached and fixed in orthogonal to the baffle plate 2. In this case, since it is formed into a shape that the baffle plate 2 cuts off between the driver units 4, 4B and the driver units 5, 5B which all of back surface sides thereof are exposed to the outside, the front-side and rear-side mounting units 60 and 70 are fixed to the baffle plate 2 so as to penetrate therethrough in a state one side group of the driver units 4, 4B and the driver units 5, 5B are removed from the front-side and rear-side mounting units 60 and 70, and then said driver units removed in advance are mounted to the front-side and rear-side mounting units 60 and 70.

In the speaker system 10 configured as above, the relationship between the front-side driver units 4 and 5, and the rear-side driver units 4B and 5B arranged adjacently on the left and right is such that the sounds in anti-phase to each other are output. Therefore, the sound and the air pressures in the spaces in the front-side mounting unit 60 and the rear-side mounting unit 70 are cancelled each other and disappeared. Consequently, the sound output from the back surface side of the respective diaphragms of the front-side driver unit 4 and the rear-side driver unit 4B reach listeners.

In contrast, when the sounds are output from the front-side driver units 4 and 4B, in the relationship with the sounds in anti-phase output from the front-side driver units 5 and 5B, since the both driver units are isolated from each other by the baffle plate 2, the sounds output from the front-side driver unit 4 and the rear-side driver unit 4B are prevented from being cancelled by the sounds in anti-phase output for the front-side driver unit 5 and the rear-side driver unit 5B and disappeared. Therefore, in the speaker system 10, in the same manner as the above speaker system 1, the audio signals recorded in the media resource are faithfully reproduced.

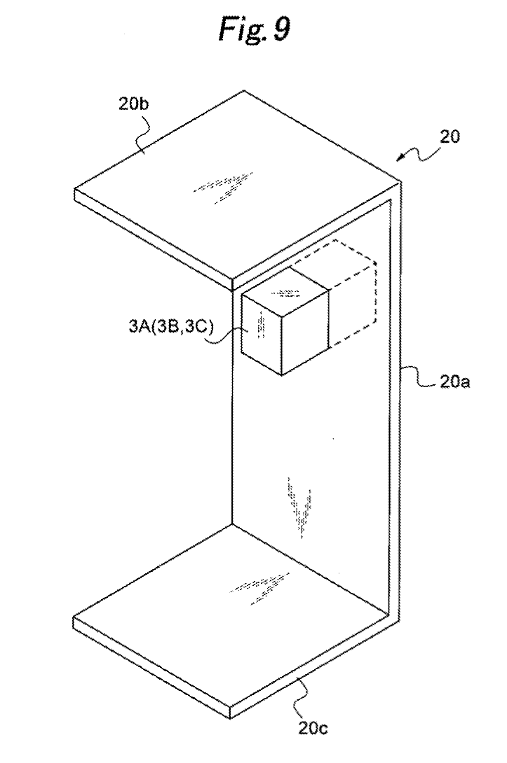

In the above mentioned speaker system, it is enough that the above speaker unit 3A, 3B or 3C is attached to such a supporting board that front side and rear side are exposed to a external space so as to penetrate therethrough. Not only the above-mentioned flat panel-shaped baffle plate 2 but also such supporting boards as shown in FIGS. 9 to 11 are available.

FIG. 9 shows a speaker system 20 including a supporting board having a rear plate 20a, a top and bottom plates 20b and 20c extending forward from the top and bottom ends of the rear plate 20a, and the speaker unit 3A, 3B or 3C attached to the rear plate 20a.

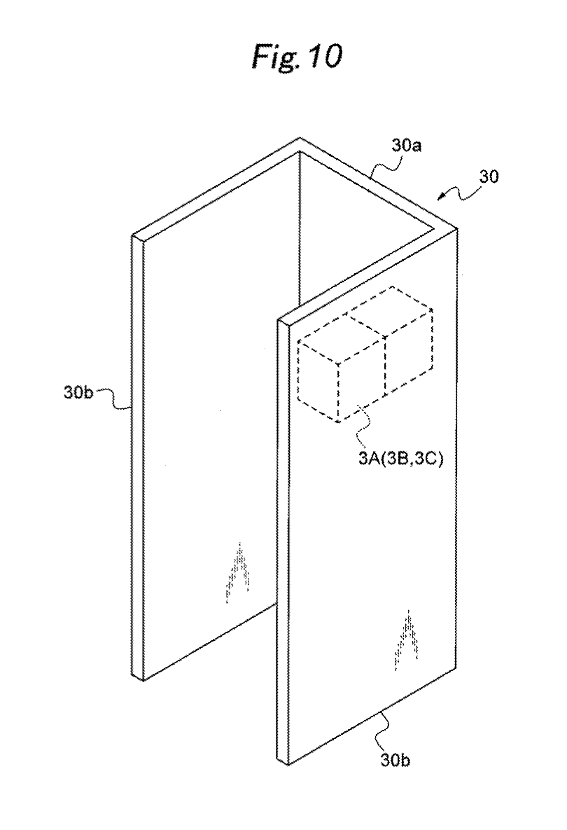

FIG. 10 shows a speaker system 30 including a supporting board having a rear plate 30a, and side plates 30b, 30b extending forward from both side ends of the rear plate 30a, and the speaker unit 3A, 3B or 3C attached to the rear plate 30a.

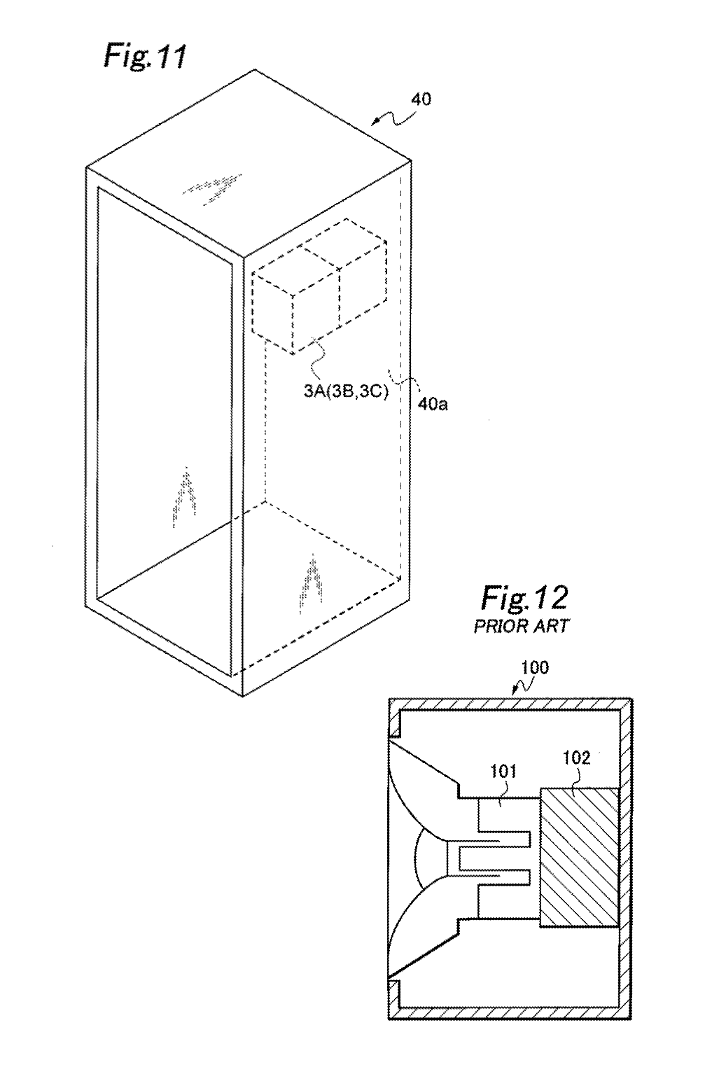

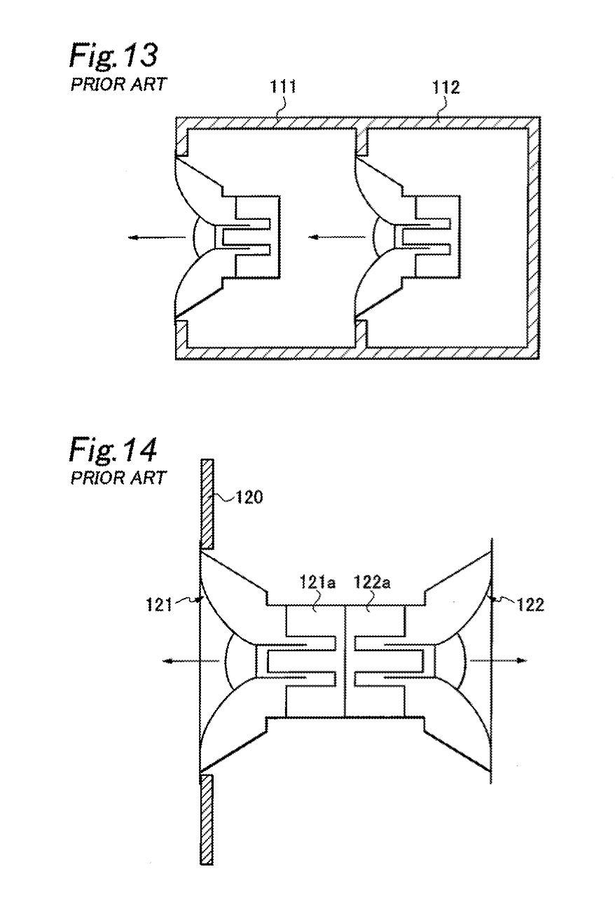

FIG. 11 shows a speaker system 40 including a supporting board formed into a tubular shape with a rear plate 40a, and a top and bottom plates and side plates extending forward from both the top and bottom ends and both side ends of the rear plate 40a, and the speaker unit 3A, 3B or 3C attached to the rear plate 40a.

### INDUSTRIAL APPLICABILITY

The speaker unit and speaker system according to the invention allows faithful reproduction of audio signals recorded in a media resource, and can be used widely in acoustical instrument technology.

What is claimed is:

1. A speaker unit comprising:
two front-side driver units arranged adjacently on the left and right, and two rear-side driver units coupled to respective magnets of the front-side driver units back to back, the two front-side driver units and the two rear-side driver units being attached to a box-shaped mounting frame,
one of the front-side driver units and one of the rear-side driver units output audio signals from a media resource, and
the other front-side driver unit and the other rear-side driver unit output signals in anti-phase to the audio signals from the media resource.

2. The speaker unit according to claim 1, wherein the mounting frame is formed into a rectangular box shape including a top plate, a bottom plate, a center supporting plate which partitions the mounting frame at the center thereof, a front surface supporting plate, a rear surface supporting plate, and both side plates (312, 312),
rear end portions of respective drivers of the front-side driver units and the rear-side driver units are inserted into and supported by through holes formed through the center supporting plate respectively, and
distal end portions of the respective diaphragms of the front-side driver units and the rear-side driver units are fixed respectively to through hole edge portions formed on the front-side supporting plate and the rear-side supporting plate.

3. The speaker unit according to claim 1, wherein the mounting frame is formed into a rectangular box shape including a top plate, a bottom plate, a front surface supporting plate, and a rear surface supporting plate, and both side plates, and
distal end portions of the respective diaphragms of the front-side driver units and the rear-side driver units are fixed respectively to through hole edge portions formed on the front-side supporting plate and the rear-side supporting plate.

4. The speaker unit according to claim 1, wherein the mounting frame includes a box-shaped front-side mounting unit and a rear-side mounting unit arranged with facing each other,
inner side surfaces of the front-side and rear-side mounting units are provided with through holes formed to correspond to distal end openings of the respective diaphragms of the front-side driver units and the rear-side driver units, and distal end opening edges of the respective diaphragms are tightly fixed to peripheral edge portions of the respective through holes, and back surface sides of the respective diaphragms are exposed to an external space.

5. A speaker system comprising:
a speaker unit claimed in claim 1, and
a supporting board, of which front side and rear side are exposed to an external space,
wherein the speaker unit is attached to the supporting board so as to penetrate therethrough.

6. The speaker system according to claim 5, wherein a mounting frame of the speaker unit is formed into a rectangular box shape including a top plate, a bottom plate, a center supporting plate which partitions the mounting frame at the center thereof, a front surface supporting plate, and a rear surface supporting plate, which are crossing through the supporting board, and both side plates, and
outer peripheral portions of the mounting frame including center portions between the adjacent front-side driver units, and between the rear-side driver units are attached and fixed to the supporting board.

7. The speaker system according to claim 5, wherein a mounting frame of the speaker unit is formed into a rectangular box shape including a top plate, a bottom plate, a front surface supporting plate, and a rear surface supporting plate, which are crossing through the supporting board, and both side plates, and
outer peripheral portions of the mounting frame including center portions between the adjacent front-side driver units and between the rear-side driver units are attached and fixed to the supporting board.

8. The speaker system according to claim 5, wherein a mounting frame of the speaker unit includes a box-shaped front-side mounting unit and a rear-side mounting unit arranged with facing each other and crossing through the supporting board,
inner side surfaces of the front-side and rear-side mounting units are provided with through holes formed to correspond to distal end openings of respective diaphragms of a front-side driver units and a rear-side driver units, and distal end opening edges of the respective diaphragms are tightly fixed to peripheral edge portions of the respective through holes, and back surface sides of the respective diaphragms are exposed to an external space,
the front-side and rear-side mounting units are crossing through the supporting board respectively, and outer peripheral portions of the front-side and rear-side mounting units including center portions between the adjacent front-side driver units, and between the rear-side driver units are attached and fixed to the supporting board respectively.

9. The speaker system according to claim 5, wherein the supporting board is a flat panel-shaped baffle plate.

10. The speaker system according to claim 5, wherein the supporting board is formed with a rear panel to which the speaker unit is attached and fixed, a top panel and bottom panel extending to forward respectively from top and bottom ends of the rear panel.

11. The speaker system according to claim 5, wherein the supporting board is formed with a rear panel to which the speaker unit is attached and fixed, and side panels extending to forward from both sides of the rear panel respectively.

12. The speaker system according to claim 5, wherein the supporting board is formed into a tubular shape with a rear panel to which the speaker unit is attached and fixed, a top and bottom panels extending to forward respectively from top and bottom ends of the rear panel, and side panels extending to forward from both sides of the rear panel respectively.
